(19) United States
(12) Patent Application Publication
(10) Pub. No.: US 2007/0176720 A1
(43) Pub. Date: Aug. 2, 2007

(54) Flux bushing for solenoid actuator

(75) Inventors: Eric P. Janssen, Howell, MI (US); Jeffrey Simmonds, Brighton, MI (US)

Correspondence Address: HARNESS, DICKEY & PIERCE, P.L.C., P.O. BOX 828, BLOOMFIELD HILLS, MI, 48303, US

(73) Assignee: Mac Valves, Inc.

(21) Appl. No.: 11/346,537

(22) Filed: Feb. 2, 2006

(51) Int. Cl. H01F 7/08

(52) U.S. Cl. 335/270

(57) ABSTRACT

A solenoid valve actuator includes a coil bobbin having a coil disposed therein and a bushing body receiving aperture. A flux plate is connected to a first end of the coil bobbin and includes a flux plate surface area. A bushing is positioned between the flux plate and the coil bobbin. The bushing includes a flange portion having a flange area substantially equal to the flux plate surface area, and a body portion integrally joined to the flange portion and extending substantially perpendicular to the flange portion. An armature is slidably received within the receiving aperture of the bushing body portion.

### FIELD

The present teachings relate in general to solenoid operators for valves and more specifically to a device and method for manufacturing a flux bushing for a solenoid operator.

### BACKGROUND

Directly operated, or actuated, pneumatic valves are known in the art for controlling the flow of pressurized fluids such as air. Directly operated valves may be used alone or in connection with, for example, spool valves and regulators that, in turn, control the flow of pressurized fluid to and from various pneumatically actuated devices such as press clutches, air brakes, sorting devices or any other pneumatic device or application requiring precise control of operating fluid. Two-way, three-way, four-way, and five-way direct operated valve assemblies are commonly employed in these environments. Such valves may include a valve body having a flow passage formed in the valve body. A valve member is supported within the flow passage and moveable from one position to another in direct response to an operative force placed on the valve member by an actuator. A plurality of ports are used to connect the valve assembly to a system supply pressure as well as the various active devices that the valve may control.

An operator or actuator such as an electromagnetically operated solenoid is commonly directly mounted to the valve body and energized to move the valve member to a predetermined position within the flow passage. A biasing device such as a spring is often employed to bias the valve member back to a known non-energized position. Valves of this type are employed in a wide variety of manufacturing environments where high flow rates and rapid response times are desired.

Common solenoid actuators include an armature which is slidably positioned within a coil bobbin, a pole plate statically positioned proximate one end of the armature, a flux plate positioned at the other end of the armature, a coil surrounding both the armature and pole plate, and a push pin or spool extension which is displaced when an electromagnetic flux is generated by the coil which drives the armature toward the pole plate. To allow the armature to slide without binding within the coil bobbin, a bushing is commonly provided having a bushing body which acts as a bearing sleeve for the armature. A flange of the bushing extends radially outward from the bushing body and partially overlaps the flux plate to retain the bushing in position with respect to the flux plate and immovable with respect to the armature.

Several drawbacks exist for common bushing designs. First, the bushing flange created by bending or rolling an end of the bushing body only partially overlaps the flux plate. This permits the bushing body to rock or tip within the coil bobbin, which can result in the armature binding or frictionally rubbing against the bushing body, which can increase the cycle time of the actuator/valve assembly and/or result in premature wear of the solenoid components. Second, an upper cover or cap is commonly provided to engage the bushing flange to the flux plate and in turn to engage the flux plate to the coil bobbin. Because common bushing flanges only partially overlap the flux plate, an air gap is created between the cap and flux plate for the remaining length of the flux plate under the cap. This air gap reduces the strength of the flux field and therefore increases the cycle time of the actuator/valve assembly.

### SUMMARY

According to several embodiments of the present teachings, a solenoid actuator bushing is provided which includes a flange portion having a flange area equaling an area of a solenoid flux plate. The solenoid actuator bushing further includes a substantially oblong-shaped body portion that is slidably disposed about a solenoid armature and disposed perpendicular to the flange portion.

According to additional embodiments of the present teachings, a valve solenoid operator is provided which includes a flux plate having a flux plate surface area. A bushing includes a flange portion disposed in contact with the flux plate, the flange portion having a flange area substantially equal to the flux plate surface area. A body portion of the bushing extends substantially perpendicular to the flange portion. An armature is slidably disposed within the body portion for displacement upon exposure to an electromagnetic flux. The electromagnetic flux is enhanced by the flange area of the flange portion.

According to still other embodiments of the present teachings, a method for creating a solenoid actuator is provided, the actuator having at least a bushing including a bushing flange and a bushing body extending perpendicularly from the bushing flange, a flux plate having a flux plate area and a bushing body receiving aperture, and an armature receivable within the bushing body. The method includes a step for sizing the bushing flange having an area substantially equal to the flux plate area. Another step includes creating an armature aperture through the bushing flange, the armature aperture co-axially alignable with a corresponding flux plate armature aperture. A further step includes slidably inserting the armature into the bushing body through the armature aperture. Still another step includes sliding the bushing body into the bushing body receiving aperture until the bushing flange abuts the flux plate, wherein the bushing flange is operable to substantially completely cover the flux plate with the armature aperture co-axially aligned with the flux plate armature aperture.

Further areas of applicability of the present teachings will become apparent from the detailed description provided hereinafter. It should be understood that the detailed description and specific examples, while indicating several embodiments of the present teachings, are intended for purposes of illustration only and are not intended to limit the scope of the present teachings.

### BRIEF DESCRIPTION OF THE DRAWINGS

The present teachings will become more fully understood from the detailed description and the accompanying drawings, wherein:

FIG. 1 is cross sectional side elevational view of a valve assembly having a valve actuator with a flux bushing of the present teachings;

FIG. 2 is an exploded assembly view of the various components for the valve actuator of FIG. 1;

FIG. 3 is a top plan view of a bushing flange of the present teachings;

FIG. 4 is a cross sectional front elevational view taken at section 4-4 of FIG. 3;

FIG. 5 is a cross-sectional side elevational view taken at section 5-5 of FIG. 3;

FIG. 6 is an exploded partial cross sectional view taken at area 6 of FIG. 4;

FIG. 7 is a bottom plan view of another embodiment of the bushing of the present teachings; and

FIG. 8 is a cross sectional front elevational view taken at section 8-8 of FIG. 7.

### DETAILED DESCRIPTION

The following description of several embodiments of the present teachings is merely exemplary in nature and is in no way intended to limit the teachings, their application, or uses.

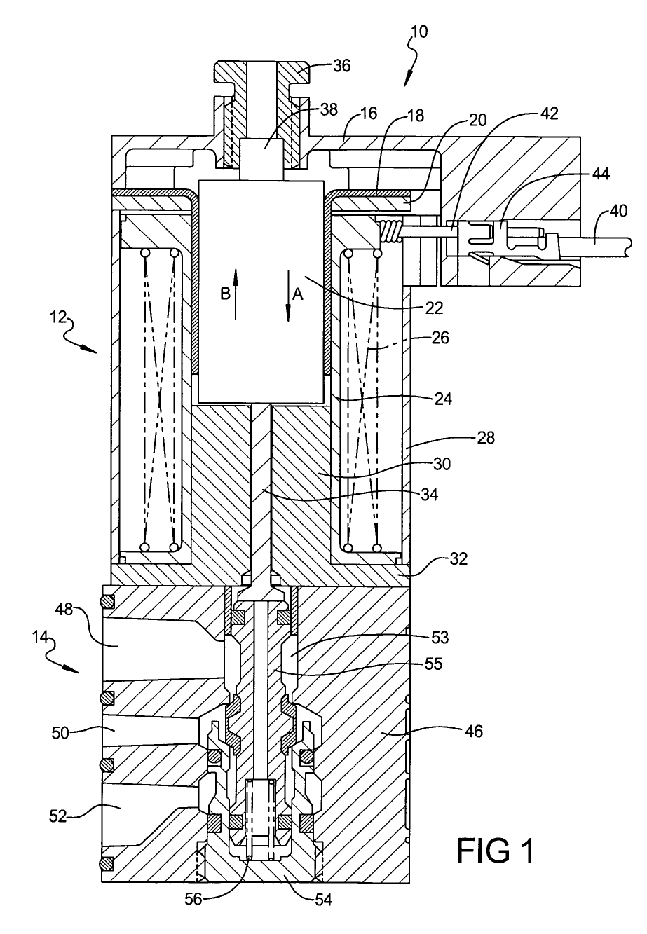

Referring generally to FIG. 1, a valve assembly 10 includes a solenoid actuator or operator 12 which can be directly connected to a valve 14. Solenoid operator 12 includes a top cover 16 which contacts a bushing 18, mechanically holding the bushing 18 between the top cover 16 and a flux plate 20. An armature 22, generally provided of a magnetic material such as a ferromagnetic material, is slidably disposed within the bushing 18. Armature 22 is capable of motion in each of an energized valve opening direction “A” and a de-energized valve closing direction “B”. Armature 22 and bushing 18 are positioned within a coil bobbin 24. A coil 26, created of a plurality of windings of an electrically conductive wire, is wound about coil bobbin 24 and is outwardly bounded by the walls of a flux frame 28. A pole plate 30 is fixed in position relative to armature 22 within coil bobbin 24. Pole plate 30 includes an integrally connected flanged end 32. In several embodiments, pole plate 30 and flanged end 32 define a homogenous component. Pole plate 30 is also made of a magnetic material, such as a ferromagnetic material. Flux plate 20 and pole plate 30 function at least as flux bearing ends of solenoid operator 12 when an electrical current is passed through coil 26 to generate an electromagnetic flux through flux plate 20, armature 22, coil bobbin 24, and pole plate 30. A stem or spool extension 34 is slidably disposed within an aperture of pole plate 30. Spool extension 34 directly contacts armature 22 and slides within pole plate 30 in direct response to longitudinal motion of armature 22 in either direction “A” or “B”.

An adjustment device 36 can be fastenably connected for example using male screw threads to female threads of top cover 16. Adjustment device 36 includes a contact end 38 which directly contacts armature 22 at an end of armature 22 opposed to the spool extension 34. Contact end 38 provides an adjustable limit or stop for upward motion in the direction of de-energized valve closing direction “B” of armature 22. By extending or retracting adjustment device 36 within top cover 16, a total travel distance or displacement of spool extension 34 can be controlled. A power supply line 40 having at least one, and commonly a plurality of conductive wires is electrically connected to a lead or connection pin 42. Connection pin 42 is in turn electrically connected via coil bobbin 24 to coil 26. A connection plug 44 is mechanically joined to power supply line 40 and provides a positive connection for power supply line 40 to top cover 16 to maintain electrical contact between power supply line 40 and connection pin 42.

With continuing reference to FIG. 1, valve 14 includes a valve body 46 abutting flanged end 32 of pole plate 30. Valve body 46 includes a plurality of ports for controlling/directing the flow of a fluid such as pressurized air within valve body 46. In several embodiments, valve body 46 includes an inlet port 48, an outlet port 50 and an exhaust port 52. Each of the inlet port 48, the outlet port 50 and the exhaust port 52 are in fluid communication with a fluid passage 53 created in valve body 46. An end retainer 54 can be adjustably fastened into an end of valve body 46 and is positioned opposite to the connection of solenoid operator 12. End retainer 54 is adjustable for example by using a threaded connection and provides an adjustable limit or stop for travel of a valve member 55 which is slidably disposed within fluid passage 53. Valve member 55 slides within fluid passage 53 by direct contact with spool extension 34 in both valve opening direction “A” and de-energized valve closing direction “B”. As valve member 55 moves within fluid passage 53, a flow passage between two of the inlet port 48, the outlet port 50 and/or the exhaust port 52 is established for flow of the pressurized fluid. A biasing element 56 such as a coiled spring is positioned between end retainer 54 and valve member 55 to provide a return force for repositioning both valve member 55 and spool extension 34 when electrical current is isolated from coil 26. Upon isolation of the electrical current, biasing element 56 forces valve member 55 and spool extension 34 to displace armature 22 in the de-energized valve closing direction “B” until armature 22 engages contact end 38 of adjustment device 36.

When electrical current is passed through coil 26, an electromagnetic flux is generated which creates a magnetic attraction force drawing armature 22 toward stationary pole plate 30. The attraction force overcomes the biasing force of biasing element 56, and armature 22, together with spool extension 34 and valve member 55 displace in the energized valve opening direction “A”. Armature 22, together with spool extension 34 and valve member 55 will remain in the displaced or valve open position until the electrical current is isolated from coil 26 and the biasing affect of biasing element 56 returns these members to the de-energized or valve closed position shown.

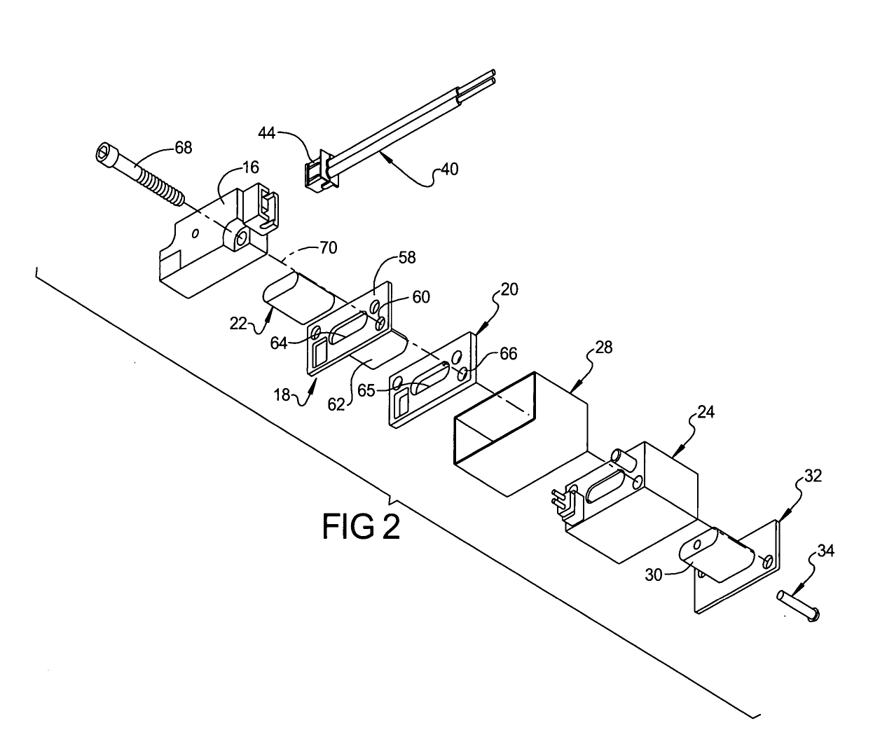

Referring generally now to FIG. 2, the assembly of various elements of solenoid operator 12 is shown. Bushing 18 includes a bushing flange 58 having at least one and commonly a plurality of fastener apertures 60 formed therethrough. A bushing body 62 which in some embodiments has a generally oblong shape is integrally joined with bushing flange 58 and extends substantially perpendicular to bushing flange 58. In some embodiments, armature 22 has a substantially oblong shape or cross section which is slidably disposed within bushing body 62 through an armature receiving aperture 64 of bushing flange 58. Bushing body 62 is then similarly received within an oblong shaped receiving aperture 65 of flux plate 20. Flux plate 20 also includes at least one and commonly a plurality of fastener through-apertures 66 which co-axially align with fastener apertures 60 when bushing flange 58 contacts and substantially completely covers flux plate 20. The assembly of armature 22, bushing 18 and flux plate 20 is disposed within coil bobbin 24, and coil bobbin 24 is then slidably disposed within flux frame 28.

The pole plate 30 is then joined at an opposite end of coil bobbin 24. Top cover 16 is then positioned over bushing flange 58 and at least one and commonly multiple fasteners 68 is/are inserted through co-axially aligned ones of the fastener apertures 60 and fastener through-apertures 66 to mechanically couple each of the components of solenoid operator 12. Fasteners 68 can be fasteners such as threaded screws, bolts, bolt-screws, or rivets, and the like. Connection plug 44 having power supply line 40 connected thereto can then be slidably connected to top cover 16. Spool extension 34 is then slidably disposed within the aperture of pole plate 30 to complete the assembly of solenoid operator 12. As shown in FIG. 2, each of the fasteners 68 is slidably disposed through corresponding and co-axially aligned ones of the fastener apertures 60 and fastener through-apertures 66 along a fastener alignment axis 70.

It is noted that the present teachings are not limited by the shape of armature 22. Armature 22 and therefore the receiving apertures 64, 65, as well as bushing body 62 and pole plate 30 can be oblong-shaped, circular, oval, rectangular, or any of a plurality of geometric shapes.

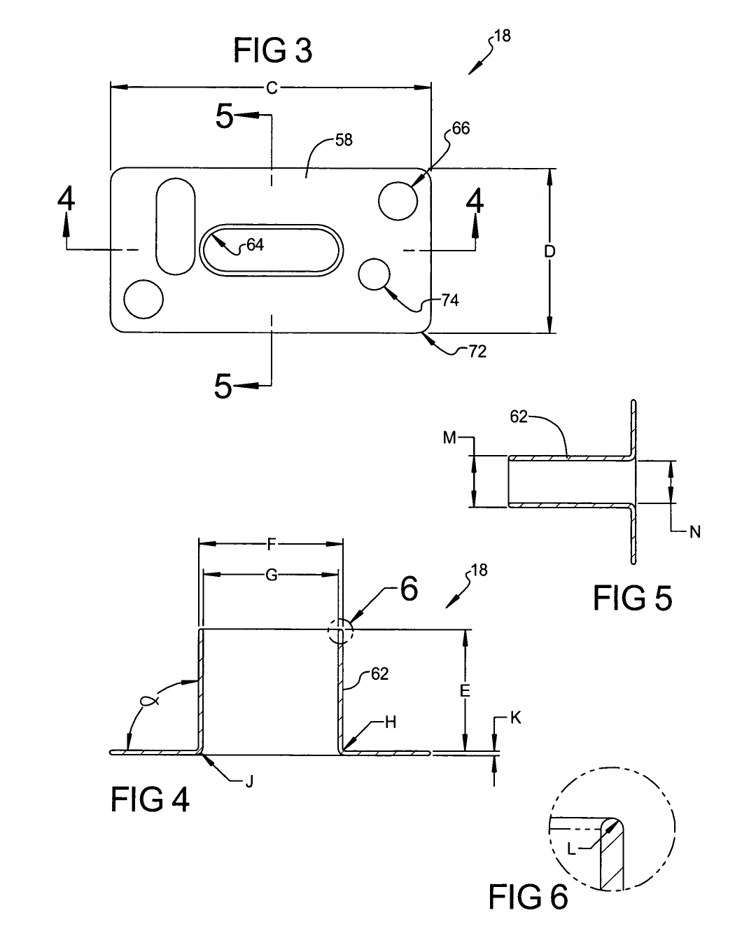

Referring now to FIGS. 3 through 6, bushing 18 in some embodiments of the present teachings is created as a drawn part having bushing body 62 drawn and extending away from bushing flange 58. Bushing flange 58 in some aspects of the present teachings is substantially rectangular shaped, having a radius corner 72 at each of the outside corners, and can also include one or more secondary apertures 74 for additional components such as electrical connections, alignment pins, or the like. Bushing flange 58 includes a flange length “C” and a flange width “D”. In an exemplary embodiment, flange length “C” is 20 mm and flange width “D” is 10 mm. Flange length “C” and flange width “D” are substantially equal to corresponding dimensions of flux plate 20, therefore an area “Z” (Z =flange length “C” X flange width “D”) of bushing flange 58 is substantially equal to a corresponding area of flux plate 20. This permits bushing flange 58 to substantially completely overlap or cover flux plate 20 when bushing body 62 is disposed within receiving aperture 65 of flux plate 20. Bushing flange 58 is not limited to the rectangular shape described above, but can be created in any geometric shape and matches a geometric shape of the flux plate 20 when flux plate 20 is used.

In further reference to FIG. 4, bushing body 62 includes a bushing body length “E” and a bushing body width “F”. In some embodiments, bushing body 62 is formed in an oblong or elongated shape corresponding to armature receiving aperture 64 of FIG. 3. This oblong shape corresponds to the oblong shape of armature 22. An armature clearance width “G” permits armature 22 to be slidingly received within bushing body 62. An outer radius “H” and an inside corner radius “J” are provided by an exemplary drawing process used to create bushing body 62 for bushing 18. In several aspects of the present teachings, a body thickness “K” is substantially retained throughout bushing 18.

As best seen with further reference to FIG. 5, bushing body 62 further includes a bushing body depth “M” and an armature clearance depth “N”. Armature clearance depth “N” together with armature clearance width “G” provide for slidable engagement of armature 22 within bushing body 62. In several embodiments of the present teachings, a preferred bushing body thickness “K” is approximately 0.20 mm. With further reference to FIG. 6, a wall end radius “L” is provided at a distal formed end of bushing body 62, which allows bushing body 62 to be slidably received within a correspondingly oblong-shaped aperture of coil bobbin 24.

Because flange length “C” and flange width “D” of bushing flange 58 substantially equal corresponding dimensions of flux plate 20, bushing flange 58 will substantially cover and engage flux plate 20 when solenoid operator 12 is assembled. By extending bushing flange 58 to entirely cover flux plate 20, no space or gap between flux plate 20 and top cover 16 can result. This effectively extends flux plate 20 to maximize the strength/effectiveness of the electromagnetic flux generated by coil 26. This can reduce the cycle time of solenoid operator 12 and therefore valve assembly 10, or reduce the power required to maintain a given valve cycle time. Reducing the power required provides a further benefit of reducing the heat generated by the solenoid actuator and its component parts, and therefore can reduce friction and wear of parts.

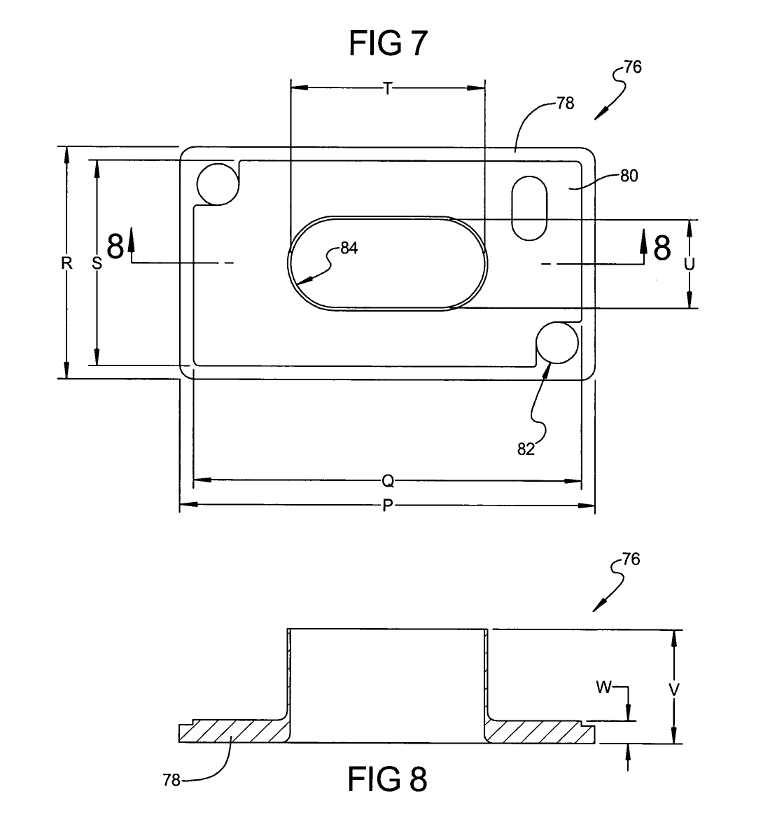

As best seen in reference to FIGS. 7 and 8, in several alternate embodiments of the present teachings, a bushing 76 is modified from bushing 18 by providing an enhanced thickness flange 78. A flange width “R” and a flange length “P” of flange 78 are substantially equal to flange length “C” and flange width “D” of bushing flange 58. A raised portion 80 is provided for flange 78 having a length “Q” and a width “S”. At least one and commonly a plurality of fastener apertures 82, similar to fastener apertures 60, are provided and are co-axially aligned similar to fastener apertures 60 to receive the plurality of fasteners 68. An armature clearance aperture 84 is substantially equal to armature receiving aperture 64. Armature clearance aperture 84 includes an armature clearance aperture length “T” and an armature clearance aperture width “U”, which are predetermined based on corresponding dimensions of armature 22 plus clearance to permit sliding motion of armature 22. A bushing body length “V” is substantially equal to bushing body length “E”. A flange thickness “W” is substantially thicker than body thickness “K” of bushing 18. The flange thickness “W” can be increased to equal or exceed the thickness of corresponding flux plate 20, therefore, by using bushing 76 flux plate 20 can be eliminated from solenoid operator 12. Bushing 76 can be manufactured using a plurality of processes including a drawing process, a welding process, and/or a machining process, as well as other manufacturing processes. Bushing 76 combines bushing 18 with flux plate 20, thereby eliminating parts and reducing costs for solenoid operator 12.

Flux bushing 18 and flux bushing 76 are created of a magnetic field coupling material such as but not limited to steel. In some embodiments, bushing 18 is also coated with a corrosion resistant material such as nickel or an oxide such as black oxide. The coating material is selected to provide both corrosion resistance and reduced friction between bushing 18 or bushing 76 and armature 22. As seen in further reference to FIG. 4, an angle a is maintained between bushing body 62 and bushing flange 58. In several embodiments, angle a is 90 degrees to maintain bushing body 62 substantially perpendicular to bushing flange 58. Angle a supports alignment of armature 22 relative to coil bobbin 24 to minimize friction between armature 22 and bushing body 62.

A flux bushing for a solenoid actuator of the present teachings offers several advantages. By extending the flange area of the bushing to substantially completely overlap or cover a flux plate or flux plate area of the actuator, the air gap previously existing where known bushing flanges are engaged by a top cover is eliminated, which therefore increases the force generated by the electromagnetic flux created by the coil. This in turn can decrease the cycle time and increase the operating speed of the actuator. Alternately, eliminating the air gap can reduce the power level to generate the electromagnetic flux or flux field, which allows a given operating speed and cycle time to be maintained using less electrical power. Operating at a lower power level can reduce the heat generated by the solenoid operator and therefore reduce operating friction and wear of parts. In addition, the larger area of the bushing flange increases the surface area in contact with the top cover of the solenoid operator assembly. This reduces the potential of the bushing body to ratchet or tip within the coil bobbin and thereby reduces friction and attendant wear between the armature and the flange body during armature motion. In some embodiments, by increasing the flange thickness of the bushing flange to a thickness substantially equal to the thickness of a flux plate, the flux plate and bushing can be combined into a single part, thereby reducing the quantity of parts and therefore the costs of the solenoid operator.

The description of the present teachings is merely exemplary in nature and, thus, variations that do not depart from the gist of the present teachings are intended to be within the scope of the present teachings. Such variations are not to be regarded as a departure from the spirit and scope of the present teachings.

What is claimed is:

1. A solenoid actuator bushing disposable between an armature and a coil bobbin, the bushing comprising:
a flange portion having a flange area substantially equal to an area of a solenoid flux plate; and
a body portion disposed perpendicular to the flange portion.

2. The bushing of claim 1, wherein a material of the bushing comprises a steel.

3. The bushing of claim 2, wherein the steel comprises a cold rolled steel.

4. The bushing of claim 2, further comprising a nickel material plated on the bushing.

5. The bushing of claim 2, further comprising an oxide material plated on the bushing.

6. The bushing of claim 1, wherein the flange portion includes at least one aperture co-axially alignable with a corresponding flux plate aperture, the at least one aperture and the flux plate aperture both being operable to receive a solenoid assembly fastener.

7. The bushing of claim 1, wherein a flange wall thickness of the flange portion is substantially equal to a body wall thickness of the body portion.

8. The bushing of claim 1, wherein a flange wall thickness of the flange portion defines a flux plate thickness, the flange portion thereby operably defining a solenoid flux plate.

9. A valve solenoid operator, comprising:
a flux plate having a flux plate surface area;
a bushing, including:
a flange portion disposed in contact with the flux plate, the flange portion having a flange area substantially equal to the flux plate surface area; and
a body portion extending substantially perpendicular to the flange portion; and
an armature slidably disposed within the body portion and operable to displace upon exposure to an electromagnetic flux field;
wherein the flange area of the flange portion operably increases the electromagnetic flux field.

10. The operator of claim 9, wherein the flange portion further comprises at least one aperture co-axially alignable with a corresponding flux plate aperture, the at least one aperture and the flux plate aperture being co-axially aligned to receive a solenoid assembly fastener.

11. The operator of claim 9, wherein a flange wall thickness of the flange portion is substantially equal to a body wall thickness of the body portion.

12. The operator of claim 9, wherein each of the flux plate, the bushing, and the armature comprise an oblong-shape, the armature being slidably received within the body portion of the bushing, and the body portion being slidably received within an oblong-shaped aperture created in the flux plate.

13. The operator of claim 9, further comprising a cover member operable to force the flange portion into contact with the flux plate.

14. The operator of claim 9, further comprising:
a coil bobbin having a coil disposed therein operable to generate the electromagnetic flux field; and
a pole member fixedly connected to the coil bobbin opposite to the flux plate.

15. A solenoid valve actuator, comprising:
a bushing, including:
a rectangular-shaped flange portion having a flange area defining a flux plate surface area; and
an oblong-shaped body portion integrally joined to the flange portion and extending substantially perpendicular to the flange portion; and
an oblong-shaped armature slidably received within the body portion;
wherein an electromagnetic flux coupled through the armature is increased by the flange area of the flange portion.

16. The actuator of claim 15, further comprising:
an actuator sub-assembly including:
a cover disposed in contact with the flange portion;
a coil bobbin including a coil, the coil bobbin having an oblong-shaped coil aperture operable to receive the oblong-shaped body portion of the bushing; and
a pole plate engageable with the coil bobbin opposite to the flange portion; and
a spool member slidably received within the pole plate.

17. The actuator of claim 16, further comprising a solenoid flux plate disposed between the cover and the flange portion operable to abuttingly engage the flange portion of the bushing, the solenoid flux plate having a surface area substantially equal to the flux plate surface area.

18. The actuator of claim 16, further comprising:
a flange wall thickness of the flange portion being greater than a body wall thickness of the body portion, the flange portion being operable as a solenoid flux plate;
wherein the flange portion is disposed between the cover and the coil.

19. The actuator of claim 16, wherein the flange portion further comprises at least one aperture operable to receive an actuator assembly fastener to couple the cover, the bushing, the coil and the pole plate.

20. The actuator of claim 15, wherein the bushing further comprises a metal material.

21. The actuator of claim 20, further comprising a corrosion resistant material coating applied to the metal material.

22. A solenoid valve actuator, comprising:
a coil bobbin having a coil disposed therein and a bushing body receiving aperture;
a flux plate connectable to a first end of the coil bobbin, the flux plate having a flux plate surface area;
a bushing positionable between the flux plate and the coil bobbin, the bushing including:
a flange portion having a flange area substantially equal to the flux plate surface area; and
a body portion integrally joined to the flange portion and extending substantially perpendicular to the flange portion; and
an armature slidably received within the body portion of the bushing.

23. The valve actuator of claim 22, further comprising a pole member fixedly disposed within the coil bobbin with respect to the armature.

24. The valve actuator of claim 23, further comprising a spool extension slidably disposed within the pole member and in contact with the armature.

25. The valve actuator of claim 22, further comprising a top cover connectable to the bushing flange portion.

26. The valve actuator of claim 22, wherein each of the flux plate and the flange portion of the bushing comprise a substantially rectangular shape.

27. The valve actuator of claim 22, wherein each of the armature, the body portion of the bushing, and the bushing body receiving aperture define a substantially oblong shape.

28. A method for creating a solenoid actuator, the actuator having at least a bushing including a bushing flange and a bushing body extending perpendicularly from the bushing flange, a flux plate having a flux plate area and a bushing body receiving aperture, and an armature receivable within the bushing body, the method comprising:
sizing the bushing flange having an area substantially equal to the flux plate area;
creating an armature aperture through the bushing flange, the armature aperture co-axially alignable with a corresponding flux plate armature aperture;
slidably inserting the armature into the bushing body through the armature aperture; and
sliding the bushing body into the bushing body receiving aperture until the bushing flange abuts the flux plate, the bushing flange operable to substantially completely cover the flux plate with the armature aperture co-axially aligned with the flux plate armature aperture.

29. The method of claim 28, further comprising creating at least one fastener aperture through the bushing flange.

30. The method of claim 29, further comprising creating at least one flux plate fastener aperture co-axially alignable with the at least one fastener aperture.

31. The method of claim 29, further comprising co-axially aligning the at least one fastener aperture with the at least one flux plate fastener aperture during the sliding step.

32. The method of claim 31, further comprising inserting a fastener through both the at least one fastener aperture and the at least one flux plate aperture to operably couple the bushing to the flux plate.

33. The method of claim 28, further comprising engaging the flux plate to a coil assembly.

34. The method of claim 33, further comprising coupling a pole plate to the coil assembly opposite to the flux plate.

35. The method of claim 28, further comprising creating the bushing body as an integral extension of the bushing flange using a drawing process.

36. The method of claim 28, further comprising creating the bushing body as an integral extension of the bushing flange using a welding/machining process.
